(19) United States
(12) Patent Application Publication
(10) Pub. No.: US 2026/0116652 A1
(43) Pub. Date: Apr. 30, 2026

(54) E-AXLE MASS ESTIMATION SYSTEM FOR REFUSE VEHICLE

(71) Applicant: Oshkosh Corporation, Oshkosh, WI (US)

(72) Inventor: Jeff Verhagen, Oshkosh, WI (US)

(73) Assignee: Oshkosh Corporation, Oshkosh, WI (US)

(21) Appl. No.: 19/368,186

(22) Filed: Oct. 24, 2025

Related U.S. Application Data
(60) Provisional application No. 63/711,842, filed on Oct. 25, 2024.

(51) Int. Cl. B65F 3/02

(52) U.S. Cl. CPC B65F 3/02; B65F 2210/184

(57) ABSTRACT

A refuse vehicle including a chassis, a body assembly coupled to the chassis, an electronic drive system coupled to the body assembly, and a controller communicably coupled to the electronic drive system. The controller is configured to receive a first triggering signal indicative of the refuse vehicle engaging a refuse container; receive, responsive to the first triggering signal, a first signal from the electronic drive system; and determine, based on the first signal, a mass of refuse contained in the refuse vehicle.

### CROSS-REFERENCE TO RELATED APPLICATIONS

This application claims the benefit of and priority to U.S. Provisional Ser. No. 63/711,842 , filed Oct. 25, 2024, the entire contents of which are hereby incorporated by reference herein.

### BACKGROUND

The present disclosure generally relates to the field of refuse vehicles. More specifically, the present disclosure relates to control systems for refuse vehicles.

### SUMMARY

One exemplary embodiment of the present disclosure relates to a refuse vehicle. The refuse vehicle includes a chassis, a body assembly coupled to the chassis, an electronic drive system coupled to the body assembly, and a controller communicably coupled to the electronic drive system. The controller is configured to receive a first triggering signal indicative of the refuse vehicle engaging a refuse container; receive (e.g., request, query, etc.), responsive to the first triggering signal, a first signal from the electronic drive system; and determine, based on the first signal, a mass of refuse contained in the refuse vehicle.

In some embodiments, the controller is further configured to determine a weight of a refuse container, based on the mass of refuse contained in the refuse vehicle. In some embodiments, the controller is further configured to make an operational determination, where the operational determination includes triggering a notification indicating for the refuse vehicle to travel to a transfer station to deposit refuse within the body assembly, based on the mass of refuse contained in the refuse vehicle. In some embodiments, the refuse vehicle further includes a lift assembly coupled to the body assembly and communicably coupled to the controller. The controller is further configured to receive the first triggering signal from the lift assembly, based on the lift assembly engaging the refuse container.

In some embodiments, the controller is further configured to receive a second triggering signal indicative of the refuse vehicle engaging a second refuse container; receive, responsive to the second triggering signal, a second signal from the electronic drive system; and determine, based on the second signal, a second mass of refuse contained in the body assembly.

In some embodiments, the controller further includes a memory unit. The controller is further configured to store the second signal from the electronic drive system in the memory unit; and determine, based on comparing the first signal and the second signal, the mass of refuse contained in the body assembly. In some embodiments, the controller is further configured to determine, based on comparing the first signal and the second signal, a weight of a refuse container. In some embodiments, the controller is further configured to make an operational determination, where the operational determination includes transmitting a notification to a customer corresponding to the refuse container, where the notification indicative of the weight of the refuse container.

In some embodiments, the electronic drive system includes an e-Axle system to at least partially drive the refuse vehicle.

Another exemplary embodiment related to a refuse vehicle including a chassis; a body assembly coupled to the chassis; an electronic drive system coupled to the body assembly; and a controller communicably coupled to the electronic drive system. The controller is configured to receive a first triggering signal indicative of a first operation of the refuse vehicle; receive, responsive to the first triggering signal, a first signal from the electronic drive system; receive a second triggering signal indicative of a second operation of the refuse vehicle different from the first operation; receive, responsive to the second triggering signal, a second signal from the electronic drive system; and determine, based on the first signal and the second signal, a mass of refuse contained in the refuse vehicle.

In some embodiments, the first triggering signal is received by the controller before collecting refuse into the body assembly of the refuse vehicle, and the second triggering signal is received by the controller after collecting refuse into the refuse vehicle. In some embodiments, the refuse is collected from a refuse container, where the refuse container corresponds to a customer. The controller may be further configured to determine an added mass of refuse from the refuse container, based on the mass of refuse contained in the refuse vehicle; and transmit a notification to the customer, where the notification is indicative of an added mass of refuse collected from the refuse container.

Another exemplary embodiment relates to a method for determining a mass of refuse. The method includes receiving a triggering signal indicative of a refuse collection operation of a refuse vehicle; receiving a signal indicative of an electronic drive system dynamics metric from an electronic drive system of the refuse vehicle, responsive to the triggering signal; and determining a mass of refuse contained within the refuse vehicle, based on the electronic drive system dynamics metric.

In some embodiments, the operation of the refuse vehicle includes depositing refuse from a refuse container into the refuse vehicle, where the refuse vehicle includes a lift assembly configured to engage the refuse container. In some embodiments, the electronic drive system dynamics metric is at least one of acceleration, torque, angular velocity, motor power, motor voltage, or pressure for the electronic drive system. In some embodiments, the triggering signal is a first triggering signal, and the signal is a first signal, where the first triggering signal is indicative of a first operation of the refuse vehicle. The first operation is performed before collecting refuse into the refuse vehicle.

In some embodiments, the method further includes receiving a second triggering signal indicative of a second operation of the refuse vehicle; and receiving a second signal indicative of an electronic drive system dynamics metric of the refuse vehicle, based on the second triggering signal. In some embodiments, the second operation of the refuse vehicle is performed after depositing refuse into the refuse vehicle. In some embodiments, the method further includes determining an added mass of refuse deposited into the refuse vehicle, based on the first signal and the second signal. In some embodiments, the method further includes determining a first mass of refuse within the refuse vehicle, based on the first signal; and determining a second mass of refuse within the refuse vehicle, based on the second signal.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a perspective view of an electronic drive system coupled to a refuse vehicle, according to an exemplary embodiment;

FIG. 5A is a perspective view of an e-Axle system that may be used as the electronic drive system of FIG. 4, according to an exemplary embodiment;

FIG. 5B is a perspective view of a brake-by-wire system that may be used as the electronic drive system of FIG. 4, according to an exemplary embodiment;

FIG. 6 is a block diagram of a mass estimation system of a refuse vehicle, according to an exemplary embodiment;

FIG. 7 is a block diagram of mass estimation system of a refuse vehicle, according to another exemplary embodiment;

FIG. 8 is a block diagram of the operation of a refuse vehicle, according to still another exemplary embodiment;

FIG. 9 is a block diagram of the operation of a refuse vehicle, according to yet another exemplary embodiment;

FIG. 10 is a flowchart of a method for determining a mass of refuse collected by a vehicle, according to an exemplary embodiment; and

FIG. 11 is a flowchart of a method for determining a mass of refuse collected by a vehicle, according to another exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Disclosed herein is a refuse vehicle. The refuse vehicle includes a chassis; a body assembly coupled to the chassis; an electronic drive system coupled to the body assembly; and a controller communicably coupled to the electronic drive system. The controller is configured to receive a first triggering signal indicative of the refuse vehicle engaging a refuse container. The controller is also configured to receive (e.g., request, query, etc.), responsive to the first triggering signal, a first signal from the electronic drive system. The controller is configured to determine, based on the first signal, a mass of refuse contained in the body assembly.

Among other benefits, determining the mass of refuse contained in a refuse vehicle increases the efficiency of a refuse collection operation, as well as aids in management of the refuse vehicle. The unique utilization of the electronic drive system to aid in determining the mass of refuse contained in the refuse vehicle allows for more efficient and accurate mass determinations. The electronic drive system may already be used to aid in driving the refuse vehicle (e.g., braking, acceleration), therefore using the electronic drive system to provide signals allowing for the determination of the mass of refuse contained in the refuse vehicle circumvents the need to add additional equipment to the refuse vehicle to make mass determinations. Further, the electronic drive system does not require equipment to be placed intrusively, in ways that may inhibit and/or complicate other aspects of the refuse collection operation (e.g., modifying existing equipment for compacting or lifting). And, using the electronic drive system can reduce maintenance requirements and associated repairs relative to using separate mass determination equipment.

A controller of the refuse vehicle is configured to receive a first triggering signal indicative of a refuse collection operation (e.g., engaging a refuse container, lifting said container, dumping the refuse into the refuse vehicle, stopping the refuse vehicle, accelerating the refuse vehicle) and to query aa first signal responsive to the first triggering signal, where the first signal is indicative of an electronic drive system dynamics metric of the refuse vehicle, such as an acceleration, torque, angular velocity, motor power, motor voltage, and/or pressure. The controller calculates the mass of refuse contained in the refuse vehicle based on the electronic drive system dynamics metric. For example, the more torque needed for the electronic drive system to begin turning a wheel of the refuse vehicle, the greater a mass of refuse in the refuse vehicle. The controller may be further configured with calibration data, stored in a memory unit, to determine what mass of refuse in the refuse vehicle requires said torque.

Moreover, the electronic drive system and controller can compare pairs of signals sent at different times, indicative of different actions of the refuse collection operation, to determine the mass of refuse in the refuse vehicle, or a change in the mass of refuse in the refuse vehicle. For example, the first triggering signal may indicate a refuse collection stop has been initiated, with the refuse vehicle braking. The electronic drive system is configured to send the first signal to the controller (e.g., responsive to the first triggering signal), where the first signal is indicative of an electronic drive system dynamics metric. The first signal, for example, may be data indicative of the torque required to stop the refuse vehicle. An initial mass of refuse (e.g., mass of the refuse vehicle) may be determined based on the first signal. In some embodiments, the first signal may be sent at the conclusion of a prior refuse collection stop, where the mass of refuse as determined at the end of the prior refuse collection stop may be the initial mass of refuse for a current refuse collection stop. After refuse has been collected at the current refuse collection stop, the second triggering signal indicates that the refuse collection stop has ended. For example, the second triggering signal may be send as the refuse vehicle accelerates away from the refuse collection stop. The electronic drive system is configured to send the second signal to the controller, based on the second triggering signal, where the second signal is indicative of an electronic drive system dynamics metric. The second signal may indicate, for example, the acceleration of the refuse vehicle after the refuse collection stop. The controller is configured to determine, based on the second signal, a current mass of refuse in the refuse vehicle (e.g., a mass of refuse or the mass of the vehicle after collecting refuse at the refuse collection stop). The controller is configured to determine, based on one or more of the two signals, the mass of refuse in the refuse vehicle (e.g., using the second signal to determine the current mass) and/or the change in mass of refuse in the refuse vehicle (e.g., based on comparing the first signal value before the stop and the second signal value after the stop). For example, based on the electronic drive system dynamics metrics, the controller may calculate the mass of refuse contained in the refuse vehicle (e.g., via mathematical data correlating the electronic drive system dynamics metrics to the mass of refuse within the refuse vehicle). The controller can also use calibration data to determine the mass of refuse in the refuse vehicle before and after the refuse collection stop, which also allows the change in the mass of refuse (e.g., a mass of refuse added to the vehicle during the stop) to be determined. The determination of the mass of refuse contained in the refuse vehicle may be used to determine if the refuse vehicle is full, notifying the refuse vehicle (or the operator) to drive to a transfer station to offload the refuse contained in the refuse vehicle. The determination of the mass of refuse contained in the refuse vehicle may also be used to notify customers, for example, to issue a warning and/or charge a fee if the refuse container was overfilled.

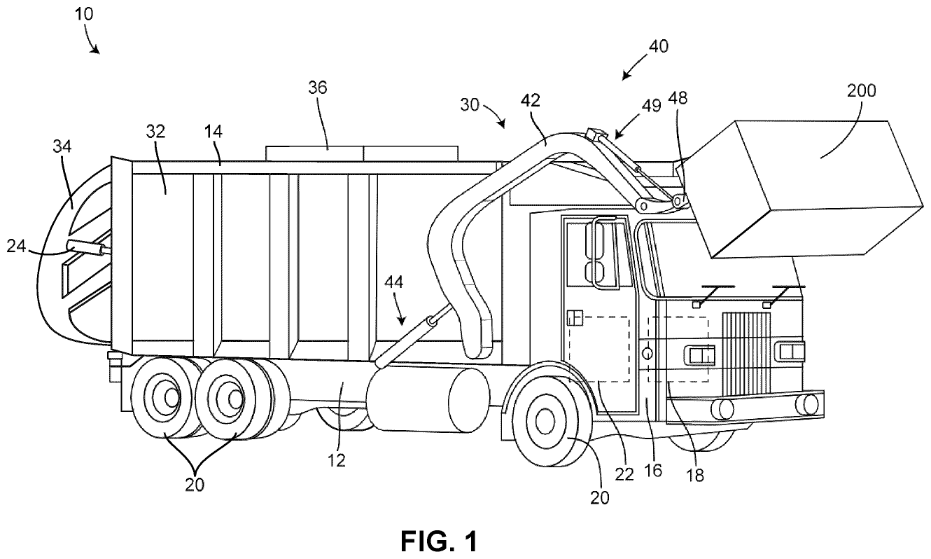

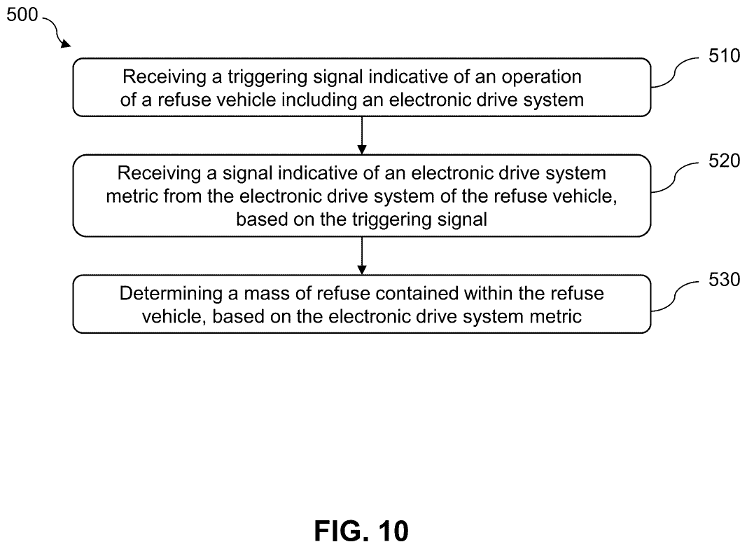

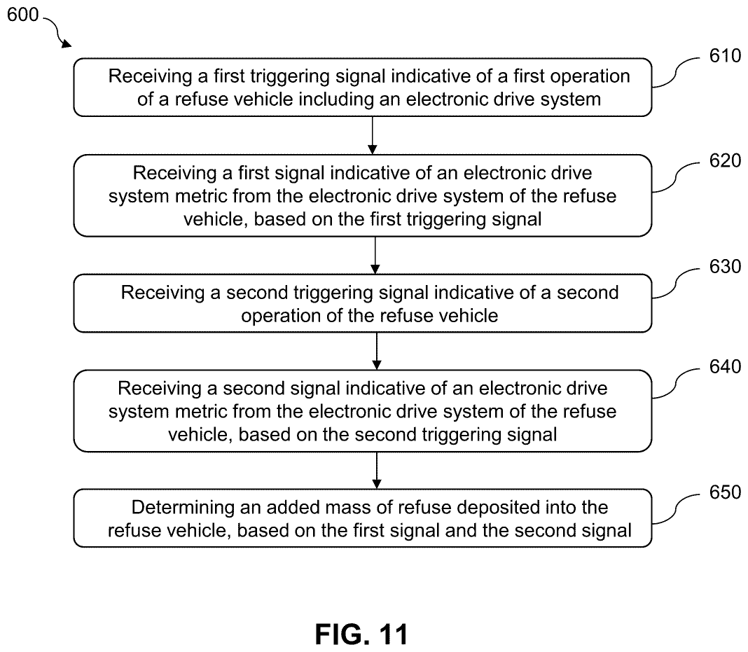

FIGS. 1 through 9 illustrate various embodiments of the refuse vehicle including the electronic drive system and controller configured to determine the mass of refuse contained in the refuse vehicle. FIGS. 10 and 11 depict various methods for determining a mass of refuse collected by the refuse vehicle, such as by an embodiment of the refuse vehicle illustrated in FIGS. 1-9.

### Refuse Vehicle

In the embodiment depicted in FIG. 1, a refuse vehicle 10 (e.g., a garbage truck, a waste collection truck, a sanitation truck, etc.) is configured to collect and store refuse. In the embodiment of FIG. 1, the refuse vehicle 10 is configured as a front-loading refuse vehicle. The refuse vehicle 10 includes a chassis, shown as frame 12; and a body assembly, shown as body 14, coupled to the chassis (shown coupled at the rear end of the frame 12). In some embodiments, the chassis is coupled in other configurations (e.g., at the front of, at the top of, at the bottom of, etc.).

In the embodiment depicted in FIG. 1, the refuse vehicle 10 further includes a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20. For example, the engine 18 may provide power to the wheels 20 through one or more axles. The engine 18 may be configured to provide power to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

In an alternative embodiment, the engine 18 includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10. In some embodiments, the refuse vehicle includes both the electric motor and the prime mover (e.g., an engine).

In some embodiments, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment depicted in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In some embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

In some embodiments, the refuse vehicle 10 further includes a lift assembly. In some embodiments, the lift assembly is coupled to the body assembly. In the embodiment depicted in FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to the frame 12 with a first pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the first pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members, shown as forks 48 (e.g., engagement forks, prongs. etc.), that are configured to removably couple with the refuse container 200 so that the refuse container 200 can be lifted and emptied. The forks 48 may be rotatably coupled to the lift arms 42 with a second pivot (e.g., a lug, a shaft, etc.). The refuse container 200 may be similar to the container attachment 200 as described in greater detail in U.S. application Ser. No. 17/558,183, filed Dec. 12, 2021, the entire disclosure of which is incorporated by reference herein. The lift assembly 40 also includes second actuators, shown as fork actuators 49 (e.g., hydraulic cylinders, etc.), coupled to the lift arms 42 and the forks 48. The fork actuators 49 are positioned such that extension and retraction thereof rotates the forks 48 about an axis extending through the second pivot, according to an exemplary embodiment.

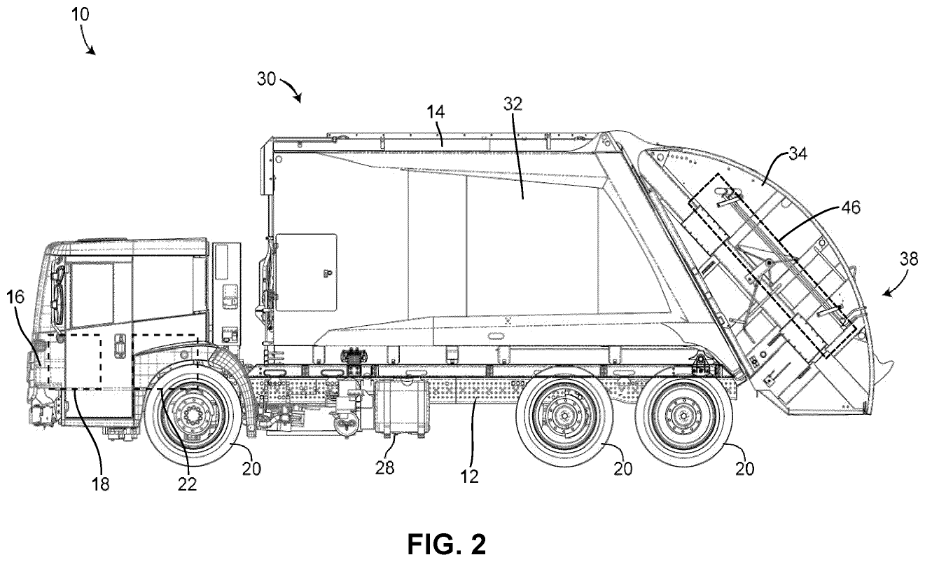

In the embodiment depicted in FIG. 2, the refuse vehicle 10 may be configured as a rear-loading refuse vehicle. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

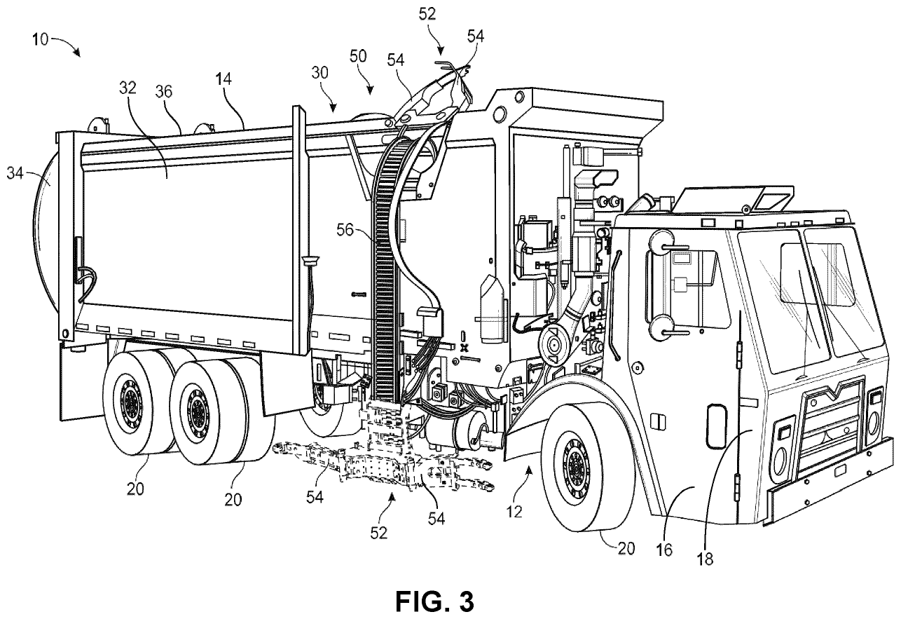

In the embodiment depicted in FIG. 3, the refuse vehicle 10 may be configured as a side-loading refuse vehicle (e.g., a zero-radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

In the embodiment depicted in FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56 and return the refuse container to the ground. Once the refuse container has been placed on the ground, the grabber assembly may transition into the disengaged state, releasing the refuse container.

### Mass Estimation System

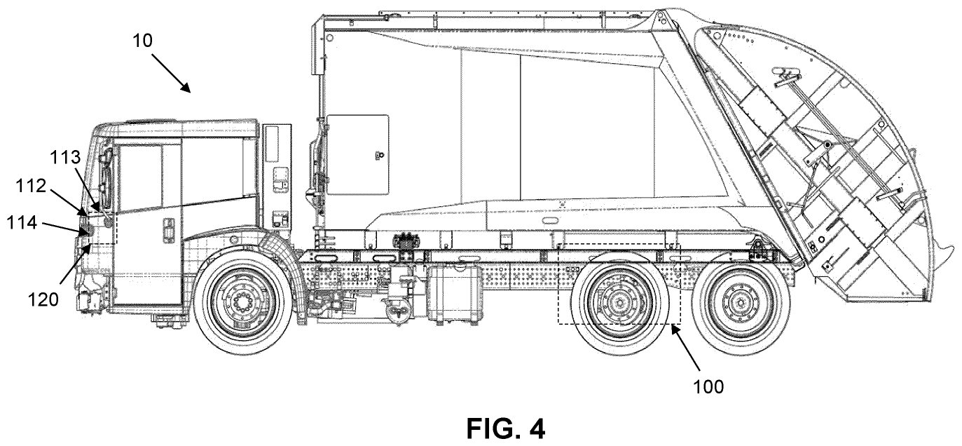

In the embodiment depicted in FIG. 4, the refuse vehicle includes an electronic drive system 100. The electronic drive system 100 is coupled to the refuse vehicle 10. In some embodiments, the electronic drive system is coupled to the body assembly 14 of the refuse vehicle. In other embodiments, the electronic drive system 100 is coupled to the chassis 12 of the refuse vehicle 10. The electronic drive system 100 may be configured with the refuse vehicle 10 in any of the above refuse vehicle embodiments (e.g., front-loading, side-loading, rear-loading, etc.).

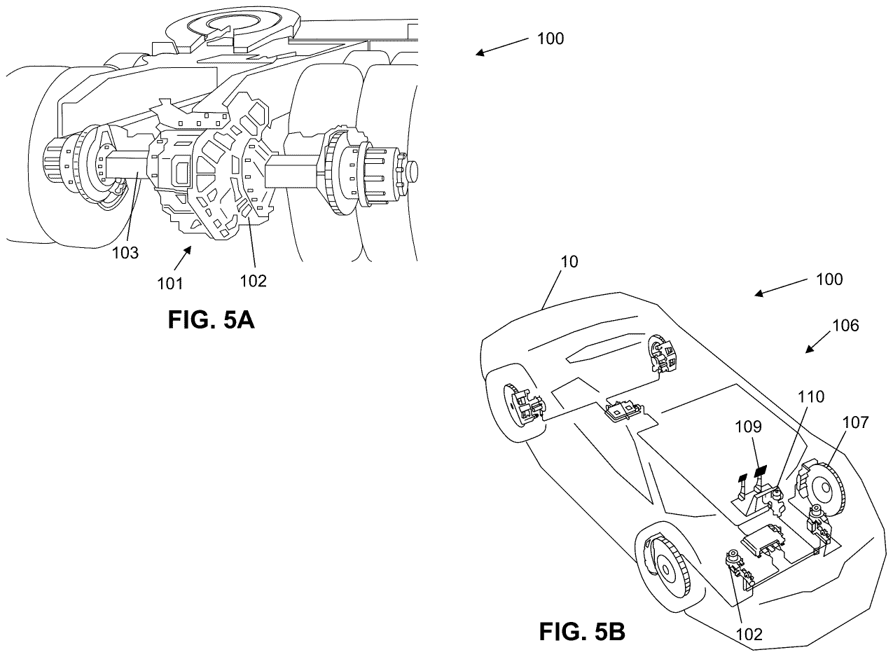

In some embodiments, the electronic drive system 100 may be or include an electric axle (e-Axle) system 101, as depicted in FIG. 5A. For example, the e-Axle system 101 may be a third-party manufactured e-Axle system, such as the e-Gen Power® made by Allison Transmission, Inc. The E-Axle system may be configured to assist in operating (e.g., accelerating, braking, etc.) a vehicle, in this case the refuse vehicle 10, using a motor 102 engaged with an axle 103 of the refuse vehicle 10. For example, the e-Axle system is configured to engage the motor 102 engaged with the axle 103 when the refuse vehicle is accelerating (e.g., from stop to start, speeding up, braking, etc.) to increase the efficiency of acceleration. The e-Axle system may be coupled to a rear axle or a front axle. One or more e-Axle systems may be used with the refuse vehicle.

In some embodiments, the electronic drive system includes a gearbox, the motor 102, and an inverter. In some embodiments, the electronic drive system operates as an 800-volt system. In some embodiments, the electronic drive system may be configured to operate at an angular velocity of upwards of 30,000 rpms, at powers of upwards of 500 kilowatts, and may be configured to produce axle torques upwards of 6000 Newton-meters. The voltage, angular velocity, power, and axle torque of the e-Axle system may be different in other embodiments, and depending on application requirements, such as the size of the refuse vehicle, weight of the refuse vehicle, expected mass of refuse within the refuse vehicle, conditions of the road, seasonal considerations, size of the electronic drive system, necessary specifications for the electronic drive system, and/or other considerations.

In some embodiments, the electronic drive system may be or include a brake-by-wire system 106, as depicted in FIG. 5B. For example, the brake-by-wire system 106 may be a third-party manufactured brake-by-wire system, such as the Electronic Braking System made by ZF Friedrichshafen AG. Brake-by-wire systems are typically used to control a brake 107 of a vehicle, in this case the refuse vehicle 10, electronically via sensors. Brake-by wire systems may include the motor 102 or a pump to control braking of the refuse vehicle. For example, an operator of the refuse vehicle may press on a brake pedal 109, which may not be coupled to a physical braking system (it may be coupled as a safety redundancy), activating a braking sensor 110 configured to measure the pressure of the operator pressing on the brake, creating a signal to send to the brake-by-wire system to activate the motor 102 and/or the pump to engage the brake 107 of the refuse vehicle 10, braking the refuse vehicle. In some embodiments, the electronic drive system includes the motor 102. In some embodiments, the electronic drive system includes the pump. The pump may be electric. In some embodiments, the electronic drive system includes the braking sensor 110. The braking sensor may be communicably coupled to the brake pedal 109. The braking sensor 110 may be communicably coupled to a second braking sensor 111 configured to the brake pedal 109. The brake-by-wire system may be coupled to a rear brake or a front brake. One or more brake-by-wire systems may be used with the refuse vehicle.

In some embodiments, the electronic drive system 100 may include both the e-Axle system 101 and the brake-by-wire system 106. In other embodiments, the electronic drive system 100 may include one or more of both the e-Axle system 101 and the brake-by-wire system 106.

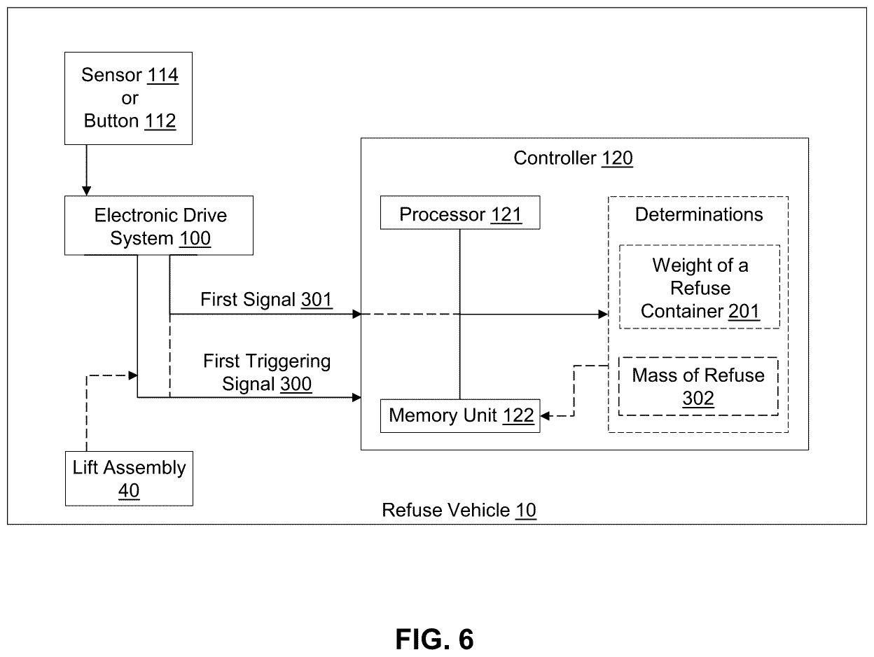

In the embodiment depicted in FIG. 6, the refuse vehicle 10 includes a controller 120. In some embodiments, the controller 120 is communicably coupled to the electric drive system 100. In some embodiments, the controller 120 may include one or more processors 121. In some embodiments, the processor 121 can be implemented as a general-purpose processor, an application specific integrated circuit (ASIC), one or more field programmable gate arrays (FPGAs), a group of processing components, or other suitable electronic processing components. In some embodiments, the controller 120 may include a memory unit 122. The memory unit 122 (e.g., memory, storage device, etc.) may include one or more devices (e.g., RAM, ROM, Flash memory, hard disk storage, etc.) for storing data. The memory unit 122 may include volatile memory or non-volatile memory. The memory unit 122 can include database components, object code components, script components, or any other type of information structure for supporting the various activities and information structures described in the present application.

In some embodiments, the controller 120 is configured to receive a first triggering signal 300 (e.g., an activation signal) indicative of certain actions being performed by the refuse vehicle 10 (e.g., driving operations, actuation of onboard systems and/or components, etc.). For example, the first triggering signal 300 may be indicative of an operation of the lift assembly 40. The first triggering signal 300 may be indicative of the refuse vehicle 10 engaging a refuse container 200. The first triggering signal 300 may be indicative of a refuse material being deposited in the body assembly 14 of the refuse vehicle 10. In some embodiments, the first triggering signal 300 may indicate a different event and/or action associated with a refuse collection operation (e.g., braking the vehicle 10, actuating the packer 46, opening/closing the tailgate 34, etc.). The lift assembly 40 may send the first triggering signal 300 to the controller 120. In some embodiments, the first triggering signal 300 may be sent by another onboard system and/or component (e.g., e-Axle system 101, packer 46, tailgate 34, driveline component, etc.). In some embodiments, the controller 120 may receive the first triggering signal 300 internally (e.g., where the first triggering signal 300 is based on another signal indicative of activation and/or control of an onboard system and/or component, such as actuating the lift assembly 40 and/or accelerating/deceleration the refuse vehicle 10, etc.).

In some embodiments, the first triggering signal 300 may be indicative of an acceleration of the refuse vehicle 10 from a refuse collection stop (e.g., after depositing refuse from within a refuse can into the refuse vehicle 10, etc.). For example, when refuse is collected, a refuse collection operation may entail approaching a refuse container, stopping the refuse vehicle, the refuse vehicle engaging with a refuse container (e.g., using the lifting assembly of the refuse vehicle), lifting the refuse container to deposit refuse material into the body assembly of the refuse vehicle, disengaging the refuse container, and accelerating the refuse vehicle to continue on a refuse collection operation (e.g., route). Any of these events and/or actions, or other events or actions associated with refuse collection operations of the refuse vehicle 10 including movement of the refuse vehicle 10 between stops, may initiate sending the first triggering signal 300 to the controller 120. The first triggering signal 300 may indicate that refuse is being added to (e.g., collected by) the refuse vehicle 10, thereby triggering (e.g., activating the controller 120, preparing for, etc.) a mass determination by the controller 120 to determine an amount (e.g., weight, mass, etc.) of refuse stored within the refuse vehicle 10, a weight of the refuse container 201 (e.g., an amount of refuse within the refuse container 200), and/or a weight of the vehicle 10 (e.g., total weight of the vehicle).

Referring to the embodiments depicted in FIGS. 4 and 6, the first triggering signal 300 may also be initiated by a push of a button 112. A switch, a lever, or similar device may be used instead of a button. The button 112 (or switch, lever, etc.) may be virtual, appearing on a user interface 113. For example, a user may push the button 112, sending the first triggering signal 300 to the controller 120. In some embodiments, a sensor 114 may be used to initiate the first triggering signal 300. The sensor 114 is communicably coupled to the controller 120. In some embodiments, the sensor 114 is communicably coupled to the electronic drive system 100. In some embodiments, one or more sensors may be used. The sensor 114 may be coupled to the refuse vehicle 10, or part thereof, to detect a desired event and/or action used to initiate the first triggering signal 300. In other words, the sensor may be used to determine when any of the events and/or actions of the refuse collection operation have begun (e.g., engaging the refuse container), to initiate sending the first triggering signal to the controller.

In the embodiment depicted in FIG. 6, the controller 120 is configured to receive, in response to the first triggering signal 300, a first signal 301 from the electronic drive system 100. In some embodiments, the controller 120 is configured to determine (e.g., calculate), based on the first signal 301, a mass of refuse 302 (e.g., stored within the body assembly) of the refuse vehicle 10. In some embodiments, the controller 120 is configured to determine, based on the first signal 301, a change in (e.g., an addition to) the mass of refuse 302. For example, the change in the mass of refuse 302 may be indicative of a mass of refuse from the refuse container 200. In some embodiments, the first signal 301 is the mass of refuse 302. In some embodiments, the first signal 301 relates to a mass of refuse 302 of the refuse vehicle 10. For example, the controller 120 may determine the mass of refuse 302 from the first signal 301.

The first signal 301 may be one or more electronic drive system dynamics metrics (e.g., data indicative of an operation of the electronic drive system 100, such as the e-Axle system 101), for example, where the first signal 301 may be torque, angular velocity, motor power, motor voltage, pressure, or another metric. For example, the electronic drive system dynamics metric may be provided by the electronic drive system 100 (e.g., the e-Axle system 101 thereof). In some embodiments, the first signal 301 is stored in the memory unit 122. In some embodiments, the mass of refuse 302 is stored in the memory unit 122. In other embodiments, the controller 120 may be configured to store other determined information in the memory unit 122, for example, the change in the mass of refuse in the body assembly. By storing the first signal 301 and/or data determined based on the first signal 301 (e.g., mass of refuse, weight of the refuse vehicle 10, etc.), the weight of the refuse vehicle 10 may be tracked (e.g., monitored) over time, and/or customers may be billed based on the amount of refuse collected from the refuse container 200 corresponding to a customer. For example, in some embodiments, the controller 120 may compare the mass of refuse 302 of the refuse vehicle 10 to a prior mass of refuse within the refuse vehicle 10 (e.g., an initial mass of refuse as of before a refuse collection stop and/or event), where an added mass of refuse 403 may be determined (e.g., an amount of refuse collected from a refuse container 200 and/or at a refuse collection stop). The prior (e.g., initial) mass of refuse in the refuse vehicle 10 may be stored within the memory unit 122 of the controller 120.

In some embodiments, the controller 120 may include mathematical data to determine the mass of refuse 302 of the refuse vehicle 10 based on the first signal 301. In some embodiments, the controller 120 may include calibration data to determine the mass of refuse based on the first signal 301. Mathematical data and/or calibration data may be store in the memory unit 122 of the controller 120. In some embodiments, the controller 120 may be configured to store intermediate information used to determine the mass of refuse 302 based on the first signal 301 (e.g., intermediate mathematical data, intermediate determinations) in the memory unit 122.

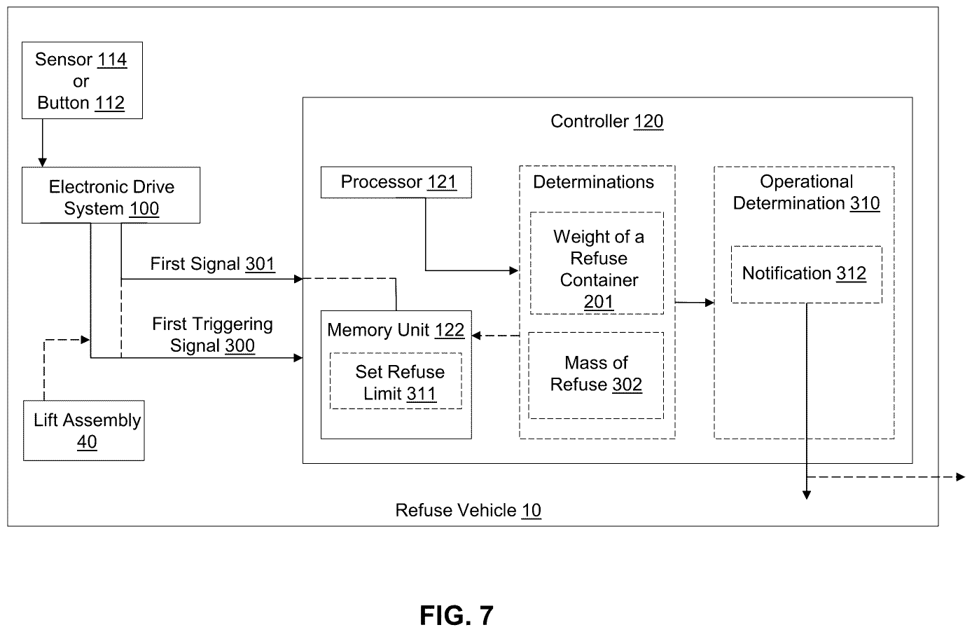

In the embodiment depicted in FIG. 7, the controller 120 is configured to make an operational determination 310. In some embodiments, the controller 120 makes the operational determination 310 based on the mass of refuse 302 of the refuse vehicle 10. For example, the controller 120 may be configured to determine if the refuse vehicle 10 is full. If the refuse vehicle is full, a notification may be triggering for the refuse vehicle to return to a transfer station to offload the refuse material. Offloading refuse material at a transfer station may be part of the refuse collection operation. In some embodiments, the controller 120 is configured with a set maximum limit of refuse 311. If the mass of refuse 302 is over the set maximum limit of refuse 311, the refuse vehicle 10 is considered full.

In the embodiments depicted in FIGS. 6 and 7, the controller 120 is configured to determine a weight of the refuse container 201. For example, the weight of the refuse container 201 may refer to a total weight of the refuse container 201 (e.g., weight of the refuse container 200 and the refuse stored therein) and/or an amount (e.g., a weight) of refuse stored within the refuse container 200 (e.g., and/or collected by the refuse vehicle 10). In some embodiments, the controller 120 is configured to determine the weight of the refuse container 201 based on the mass of refuse 302 of the refuse vehicle 10 (e.g., by determining an added mass of refuse based on comparing the mass of refuse 302 to the prior mass of refuse before the refuse collection stop and/or event). An empty weight of the refuse container 200 may be known, and thereby may be stored in the memory unit 122 or the controller 120. For example, the weight of the refuse container 201 may refer to the mass (and/or weight) of refuse within said container and/or a total weight of the refuse container 200 and the refuse stored within. In some embodiments, the weight of a refuse container 201 may be used to make the operational determination 310. For example, if the weight of the refuse container 201 (e.g., the amount of refuse stored therein) is over a set refuse container weight limit 202, a customer of said refuse container may be issued (e.g., sent, transmitted, etc.) a notification 312. Said notification may be a warning or a charged fee. Collecting money from refuse customers may be part of a refuse collection operation. The fleet manager, or other individual responsible for the refuse collection operation (or a component thereof), may be issued the notification. For example, the notification may be sent to a system used to manage the refuse collection operation (e.g., the computer system at a managing office).

In some embodiments, the controller 120 is configured with mathematical, calibration, and/or preset data. For example, the controller 120 may be configured to set limits for the refuse vehicle being full and/or refuse container being overweight, or other desired operational specification.

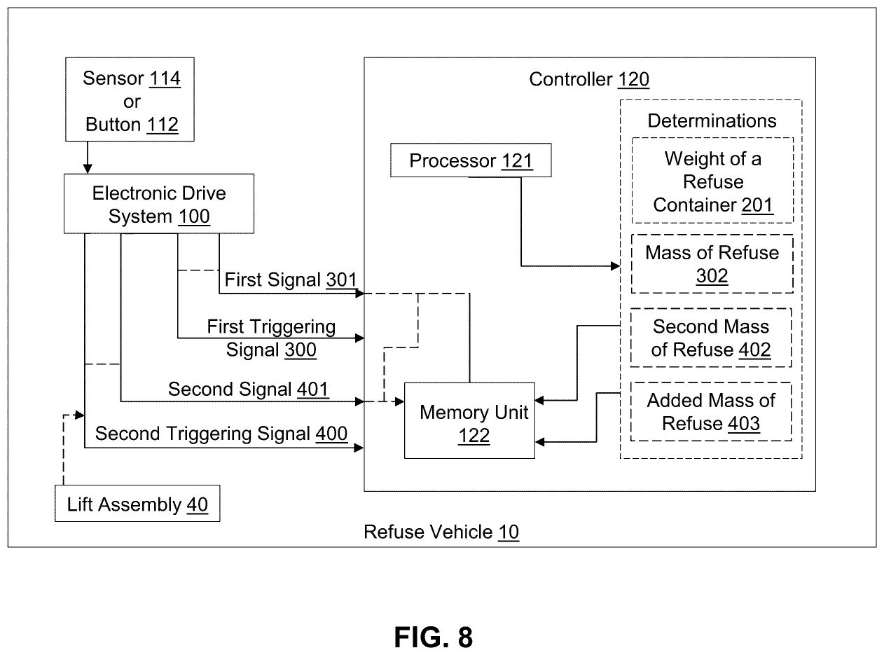

In the embodiment depicted in FIG. 8, the controller 120 receives a second triggering signal 400 (e.g., an activation signal) indicative of certain actions being performed by the refuse vehicle 10 (e.g., driving operations, actuation of onboard systems and/or components, etc.). For example, the second triggering signal may be indicative of an operation of the lift assembly 40. The second triggering signal 400 may be indicative of the refuse vehicle 10 engaging the refuse container 200. In some embodiments, the refuse container 200 may be a second refuse container 210 (not shown). The second triggering signal 400 may indicate of refuse material being deposited in the body assembly of the refuse vehicle 10. In some embodiments, the lift assembly 40 may send the second triggering signal 400 to the controller 120. In some embodiments, the second triggering signal 400 may be sent by another onboard system and/or component (e.g., e-Axle system 101, packer 46, tailgate 34, driveline component, etc.). In some embodiments, the controller 120 may receive the second triggering signal 400 internally (e.g., where the second triggering signal 400 is based on another signal indicative of activation and/or control of an onboard system and/or component, such as actuating the lift assembly 40 and/or accelerating/deceleration the refuse vehicle 10, etc.).

In some embodiments, the second triggering signal is the acceleration of the refuse vehicle. For example, when refuse is collected, the process generally entails approaching a refuse container, stopping the refuse vehicle, the refuse vehicle engaging with a refuse container (e.g., using the lifting assembly of the refuse vehicle), lifting the refuse container to deposit refuse material into the body assembly of the refuse vehicle, disengaging the refuse container, and accelerating the refuse vehicle to continue on a refuse collection operation (e.g., route). Any of these events and/or actions, or other events or actions of the refuse collection operation, may initiate sending the second triggering signal 400 to the controller 120. The second triggering signal 400 may indicate that refuse is being added to (e.g., collected by) the refuse vehicle 10, thereby triggering (e.g., activating the controller 120, preparing for, etc.) a mass determination by the controller 120 to determine an amount (e.g., weight, mass, etc.) of refuse stored within the refuse vehicle 10, a weight of the refuse container 201, and/or a weight of the vehicle 10 (e.g., total weight of the vehicle).

In the embodiments depicted in FIGS. 4 and 8, the second triggering signal 400 is initiated by a push of the button 112. A switch, a lever, or similar device may be used instead of a button. The button 112 (or switch, lever, etc.) may be virtual, appearing on the user interface 113. For example, a user may push the button 112, sending the second triggering signal 400 to the controller 120. In some embodiments, the sensor 114 may be used to initiate the second triggering signal 400. The sensor 114 is communicably coupled to the controller 120. In some embodiments, the sensor 114 is communicably coupled to the electronic drive system 100. In some embodiments, one or more sensors may be used. The sensor 114 may be coupled to the refuse vehicle 10, or part thereof, to detect a desired event and/or action used to initiate the second triggering signal 400. In other words, the sensor may be used to determine when any of the events and/or actions of the refuse collection operation have begun (e.g., engaging the refuse container), to initiate sending the second triggering signal to the controller.

In some embodiments, the controller 120 is configured to receive a second signal 401 from the electronic drive system 100. In some embodiments, the controller 120 receives, responsive to the second triggering signal 400, the second signal 401 from the electronic drive system 100. In some embodiments, the controller 120 determines, based on the second signal 401, a second mass of refuse 402 of the refuse vehicle 10. In other embodiments, the controller 120 is configured to determine, based on the second signal 401, a change in (e.g., an addition to) the mass of refuse in the body assembly. For example, the change in the mass of refuse in the body assembly may be indicative of a mass of refuse from the refuse container 200. In some embodiments, the second signal 401 is the second mass of refuse 402. In some embodiments, the controller 120 determines the second mass of refuse 402 from the second signal 401. The second signal 401 relates to the second mass of refuse 402.

For example, the second signal 401 may be the electronic drive system dynamics metric (e.g., data indicative of an operation of the electronic drive system 100, such as the e-Axle system 101), for example, where the second signal 401 may be torque, angular velocity, motor power, motor voltage, pressure, or another metric. For example, the electronic drive system dynamics metric may be provided by the electronic drive system 100 (e.g., the e-Axle system 101 thereof). In some embodiments, the controller 120 stores the second signal 401 in the memory unit 122. In some embodiments, the controller 120 stores the second mass of refuse 402 in the memory unit 122. In other embodiments, the controller 120 may be configured to store other determined information in the memory unit 122, for example, the change in the mass of refuse in the body assembly. By storing the second signal 401 and/or data determined based on the second signal 401 (e.g., mass of refuse, weight of the refuse vehicle 10, etc.), the weight of the refuse vehicle 10 may be tracked (e.g., monitored) over time, and/or customers may be billed based on the amount of refuse collected from the refuse container 200 corresponding to a customer.

In some embodiments, the controller 120 may include mathematical data to determine the second mass of refuse 402 of the refuse vehicle 10 based on the second signal 401. In some embodiments, the controller 120 may include calibration data to determine the second mass of refuse 402 based on the second signal 401. Mathematical data and/or calibration data may be store in the memory unit 122 of the controller 120. In some embodiments, the controller 120 may be configured to store intermediate information used to determine the second mass of refuse 402 based on the second signal 401 (e.g., intermediate mathematical data, intermediate determinations) in the memory unit 122.

Referring to FIG. 8, the controller 120 may be configured to determine, based on comparing the first signal 301 and the second signal 401, the mass of refuse stored within the refuse vehicle 10 (e.g., the mass of refuse 302, the second mass of refuse 402). The controller 120 may include calibration data to determine the mass of refuse 302 given the first signal 301 and/or the second signal 401. In some embodiments, the controller 120 may be configured to determine an added mass of refuse 403 of the refuse vehicle 10. The added mass of refuse 403 indicates a change in the mass of refuse 302 between the first triggering signal 300 and the second triggering signal 400 (e.g., where the first triggering signal 300 and/or the first signal 301, and the second triggering signal 400 and/or the second signal 401 occur at different points in time, such as at different refuse collection stops along a refuse collection route). For example, the controller 120 may determine the first (e.g., initial) mass of the refuse vehicle 10 (e.g., a vehicle mass before a refuse stop and/or event) based on the first signal 301, and the second mass of the refuse vehicle 10 (e.g., a vehicle mass after a refuse stop) based on the second signal 401. By comparing the second mass of the refuse vehicle 10 to the first mass of the refuse vehicle 10, the added mass of refuse 403 is determined. The first triggering signal 300 and/or the first signal 301 may be used to determine a first mass of refuse (e.g., an initial mass of refuse as of before a refuse collection stop), where the second triggering signal 400 and/or the second signal 401 may be used to determine a second mass of refuse (e.g., a current mass of refuse as of after a refuse collection stop). The controller 120 may determine if refuse was added to the body assembly of the refuse vehicle 10 between the two triggering signals 300, 400 (e.g., at a refuse collection stop) by determining and comparing a first mass of refuse (e.g., an initial mass of refuse, the mass of refuse 302) to a second mass of refuse (e.g., a current mass of refuse, the second mass of refuse 402) in the body assembly (e.g., in the hopper) of the refuse vehicle. For example, the controller 120 may determine the added mass of refuse 403 based on comparing the mass of refuse 302 and the second mass of refuse 402. For example, if the second mass of refuse 402 is greater than the mass of refuse 302, then refuse material was added to the refuse vehicle 10. In some embodiments, the controller 120 determines if refuse material was added to the refuse vehicle 10 by comparing the first signal 301 to the second signal 401.

The controller 120 may determine if refuse material was added to the refuse vehicle 10 by comparing the first signal 301 and the second signal 401 when either or both are the mass of refuse 302 and/or the second mass of refuse 402. The controller 120 may determine if refuse material was added to the refuse vehicle when either or both the first signal 301 and the second signal 401 are torque, angular velocity, motor power, motor voltage, pressure, or other metric. For example, if the first signal 301 is a first torque, and the second signal 401 is a second torque, and the first torque is greater than the second torque, then refuse material was added to the refuse vehicle 10. The controller 120 may determine if refuse material was added to the refuse vehicle if the first signal 301 and the second signal 401 are different metrics. For example, the controller 120 may be configured with mathematical and/or calibration data to compare the first signal 301 to the second signal 401 to determine the mass of refuse 302, or other relevant determination.

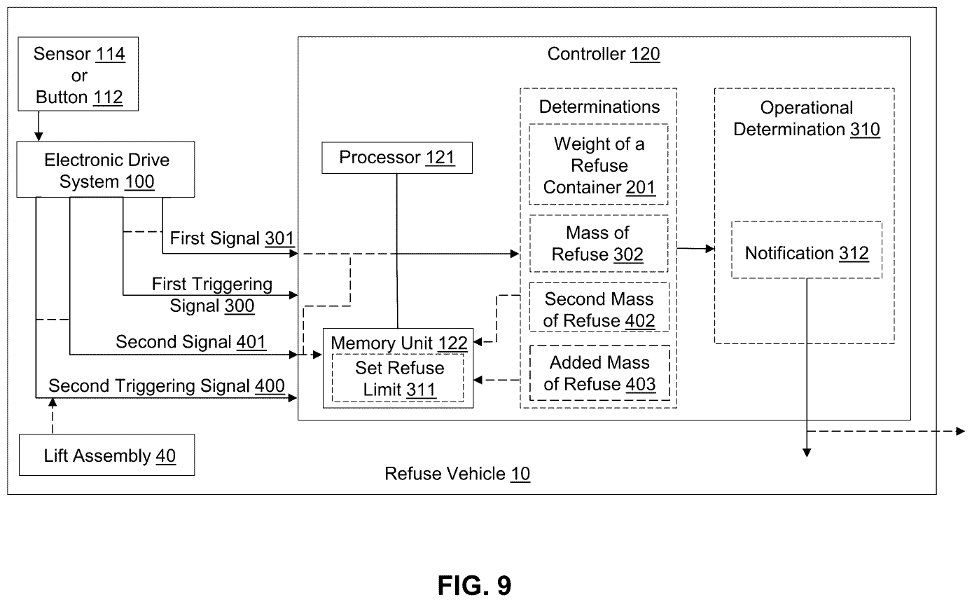

In the embodiment depicted in FIG. 9, the controller 120 is configured to make an operational determination 310. In some embodiments, the controller 120 makes the operational determination 310 based on comparing the first signal 301 and the second signal 401. The first signal 301 may relate to the mass of refuse 302 of the refuse vehicle 10. The second signal may relate to the second mass of refuse 402. In some embodiments, either or both of the first signal 301 and/or the second signal 401 may be torque, angular velocity, motor power, motor voltage, pressure, or other metric. In some embodiments, the mass of refuse 302 is determined based on comparing the first signal 301 and the second signal 401. For example, the controller 120 may be configured to determine if the refuse vehicle 10 is full. If the refuse vehicle 10 is full, a notification 312 may be triggering for the refuse vehicle to return to a transfer station to offload the refuse material. In some embodiments, the controller 120 is configured with the set maximum limit of refuse 311. If the mass of refuse 302 is over the set maximum limit of refuse 311, the refuse vehicle 10 is considered full.

In the embodiments depicted in FIGS. 8 and 9, the controller 120 is configured to determine, based on comparing the first signal 301 and the second signal 401, the weight of the refuse container 201. For example, the weight of the refuse container 201 may refer to a total weight of the refuse container 201 (e.g., weight of the refuse container 200 and the refuse stored therein) and/or an amount (e.g., a weight) of refuse stored within the refuse container 200 (e.g., and/or collected by the refuse vehicle 10). In some embodiments, the controller 120 is configured to determine the weight of the refuse container 201 based on the mass of refuse 302 and/or the second mass of refuse 402 of the refuse vehicle 10. For example, by determining the added mass of refuse 403 (e.g., at the refuse collection stop and/or event), the weight of the refuse container 201 (e.g., the weight of refuse stored therein) may be determined. The empty weight of the refuse container 200 may be known, and thereby may be stored in the memory unit 122 or the controller 120. For example, the weight of the refuse container 201 may refer to the mass (and/or weight) of refuse within said container and/or a total weight of the refuse container 200 and the refuse stored within. Thereby, the controller 120 may be configured to determine the weight of the refuse container 201 mathematically, including by subtracting the first signal 301 and/or the mass of refuse 302 (e.g., the previous data values stored in the memory unit 122 and/or corresponding to the first triggering signal 300) from the second signal 401 and/or the second mass of refuse 402 (e.g., the current data values corresponding to the second triggering signal 400). In some embodiments, the controller 120 may determine the weight of the refuse container 201 when either or both of the first signal 301 and/or the second signal 401 are torque, angular velocity, motor power, motor voltage, pressure, or other metric. The controller 120 may be configured with mathematical and/or calibration data to compare the first signal 301 to the second signal 401 to determine the weight of the refuse container 201.

In the embodiment depicted in FIG. 9, the weight of the refuse container 201 may be used to make the operational determination 310. For example, if the weight of the refuse container 201 is over the set refuse container weight limit 202, a customer of said refuse container may be issued the notification 312. Said notification may be a warning or a charged fee. The fleet manager, or other individual responsible for the refuse collection operation (or a component thereof), may be issued the notification. For example, the notification may be sent to a system used to manage the refuse collection operation (e.g., the computer system at a managing office).

With reference to the embodiments depicted in FIGS. 1-9, the refuse vehicle 10 may be an autonomous refuse vehicle that is configured to operate without or with minimal user input. In some embodiments, the refuse vehicle 10 is semi-autonomous and is configured to operate based on user inputs for at least certain functions. In some embodiments, the operational determination 310 may be used as part of an autonomous and/or semi-autonomous vehicle application. Further, any of the mentioned determinations made by the controller 120 may be used as part of an autonomous and/or semi-autonomous vehicle application. In some embodiments, one or more of the first triggering signal 300, the first signal 301, the second triggering signal 400, the second signal 401, the mass of refuse 302, and/or the weight of the refuse container 201 may be used as part of an autonomous and/or semi-autonomous vehicle application.

Referring to FIGS. 10 and 11, methods 500, 600 for determining a mass of refuse collected by a vehicle, such as a refuse vehicle, are depicted. In some embodiments, the method 500 and/or the method 600 may include additional, fewer, and/or an additional order of steps. In some embodiments, the method 500 and/or the method 600 may be carried out using an embodiment of the refuse vehicle 10, for example, with the refuse vehicle 10 including an embodiment of the electronic drive system 100, as described herein.

As shown in FIG. 10, the method 500 includes receiving a triggering signal indicative of an operation of a refuse vehicle, where the refuse vehicle includes an electronic drive system, at 510. For example, the electronic drive system may be an e-Axle system and/or a brake-by-wire system. The operation of the refuse vehicle may part of a refuse collection operation (e.g., collecting refuse from a refuse container and storing said refuse within the refuse vehicle), including, but not limited to, approaching a refuse container, stopping the refuse vehicle, the refuse vehicle engaging with a refuse container (e.g., using the lifting assembly of the refuse vehicle), lifting the refuse container to deposit refuse material into the body assembly of the refuse vehicle, disengaging the refuse container, and accelerating the refuse vehicle to continue on a refuse collection operation (e.g., route).

The method 500 further includes receiving a signal (e.g., different from the triggering signal) indicative of an electronic drive system dynamics metric from the electronic drive system, based on the triggering signal, at 520. The electronic drive system metric may refer to a performance metric for the electronic drive system during an operation of the refuse vehicle (e.g., braking, accelerating, turning, etc.). For example, the electronic drive system dynamics metric may be torque, angular velocity, motor power, motor voltage, pressure, or another metric. The method 500 may further include determining a mass of refuse contained within the refuse vehicle, based on the electronic drive system dynamics metric, at 530. Thereby, the mass of refuse (e.g., and/or a mass of the vehicle) may be determined, which increases the efficiency of a refuse collection operation and aids in management of the refuse vehicle. In some embodiments, the triggering signal may activate (e.g., initiate, prompt, etc.) a controller and/or other electronic device (e.g., onboard the refuse vehicle, remotely to a cloud controller, etc.) to determine the mass of refuse collected by the refuse vehicle. The signal may provide the electronic drive system dynamics metric to the controller and/or other electronic device, such that the controller may determine (e.g., calculate) the mass of refuse based on the electronic drive system dynamics metric.

In some embodiments, the triggering signal and the signal may be the same signal and/or sent simultaneously. In some embodiments, the method may include determining one or more additional amounts (e.g., masses and/or weights) of refuse and/or refuse containers engaged by the refuse vehicle during a refuse collection operation (e.g., a weight of a refuse container, a mass of refuse collected from the refuse container, etc.). In some embodiments, the method 500 may include determining an operation determination based on the mass of refuse, as described herein (e.g., indicating that the refuse vehicle is full and to travel to a transfer station, sending a notification to a customer including billing information and/or a warning based on the mass of refuse collected from the customer's refuse container, etc.).

As shown in FIG. 11, the method 600 includes receiving a first triggering signal indicative of a first operation of a refuse vehicle, where the refuse vehicle includes an electronic drive system, at 610. For example, the electronic drive system may be an e-Axle system and/or a brake-by-wire system. The operation of the refuse vehicle may part of a refuse collection operation (e.g., collecting refuse from a refuse container and storing said refuse within the refuse vehicle), including, but not limited to, approaching a refuse container, stopping the refuse vehicle, the refuse vehicle engaging with a refuse container (e.g., using the lifting assembly of the refuse vehicle), lifting the refuse container to deposit refuse material into the body assembly of the refuse vehicle, disengaging the refuse container, and accelerating the refuse vehicle to continue on a refuse collection operation (e.g., route).

The method 600 further includes receiving a first signal (e.g., different from the first triggering signal) indicative of an electronic drive system dynamics metric from the electronic drive system, based on the first triggering signal, at 620. The electronic drive system dynamics metric may refer to a performance metric for the electronic drive system during an operation of the refuse vehicle (e.g., braking, accelerating, turning, etc.). For example, the electronic drive system dynamics metric may be torque, angular velocity, motor power, motor voltage, pressure, or another metric.

The method 600 further includes receiving a second triggering signal indicative of a second operation of the refuse vehicle, at 630. The method 600 further includes receiving a second signal indicative of an electronic drive system dynamics metric from the electronic drive system of the refuse vehicle, based on the second triggering signal, at 640. For example, the first signal and the second signal may be similar, such that the signals may include the same electronic drive system dynamics metric (e.g., acceleration, torque, etc.). In some embodiments, the first signal and the second signal may include different electronic drive system dynamics metrics. The method 600 further includes determining an added mass of refuse deposited into the refuse vehicle, based on the first signal and the second signal, at 650.

In some embodiments, the first triggering signal may activate (e.g., initiate, prompt, etc.) a controller and/or other electronic device (e.g., onboard the refuse vehicle, remotely to a cloud controller, etc.) to determine the mass of refuse stored within the refuse vehicle. The first signal may provide the electronic drive system dynamics metric to the controller and/or other electronic device, such that the controller may determine (e.g., calculate) the mass of refuse based on the electronic drive system dynamics metric. The mass of refuse based on the first signal may be an initial mass of refuse within the refuse vehicle (e.g., at a beginning of a refuse collection stop, before depositing refuse into the refuse vehicle via the lift assembly thereof, etc.). For example, the first operation of the refuse vehicle (e.g., triggering the first triggering signal) may be an operation before collecting refuse, such as from a refuse container (e.g., beginning a refuse collection stop, before depositing refuse into the refuse vehicle via the lift assembly thereof, etc.). During the refuse collection stop, the refuse vehicle collects refuse (e.g., from a customer's refuse container and/or location). The second triggering signal may activate (e.g., initiate, prompt, etc.) the controller and/or other electronic device to determine the mass of refuse stored within the refuse vehicle, for example, after the refuse collection stop. The second signal may provide the electronic drive system dynamics metric to the controller and/or other electronic device, such that the controller may determine (e.g., calculate) the mass of refuse based on the electronic drive system dynamics metric. The mass of refuse based on the second signal may be a current mass of refuse within the refuse vehicle (e.g., after the refuse collection stop, after depositing refuse into the refuse vehicle via the lift assembly thereof, etc.). For example, the second operation of the refuse vehicle may be an operation after collecting refuse, such as from the refuse container, and storing said refuse in the refuse vehicle (e.g., completing the refuse collection stop, after depositing refuse into the refuse vehicle via the lift assembly, etc.). The initial mass of refuse (e.g., before the refuse collection stop) and the current mass of refuse (e.g., after the refuse collection stop) may be determined, such that the added mass of refuse may be determined (e.g., the amount of refuse collected from a customer's refuse container and/or location). For example, the added mass of refuse may be determined by comparing the current mass of refuse to the initial mass of refuse.

By determining the mass of refuse (e.g., and/or a mass of the vehicle), the mass of refuse and/or of the vehicle may be tracked over time, thereby increasing the efficiency of a refuse collection operation and aiding in management of the refuse vehicle. Furthermore and/or in addition to, by determining the added mass of refuse, the accuracy of customer billing and/or the tracking of customer refuse disposal habits may be increased, thereby increasing the efficiency of the refuse collection operation.

With reference to the methods depicted in FIGS. 10-11, in some embodiments, the methods 500, 600 may be performed autonomously, such as part of operation of an autonomous refuse vehicle that is configured to operate without or with minimal user input. In some embodiments, the method 500, 600 may be semi-autonomous and are configured to operate based on user inputs for at least certain method steps.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,”“substantially,”and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims. It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body assembly coupled to the chassis;
an electronic drive system coupled to the body assembly; and
a controller communicably coupled to the electronic drive system, the controller configured to:
receive a first triggering signal indicative of the refuse vehicle engaging a refuse container;
receive, responsive to the first triggering signal, a first signal from the electronic drive system; and
determine, based on the first signal, a mass of refuse contained in the refuse vehicle.

2. The refuse vehicle of claim 1 comprising the controller, wherein the controller is further configured to determine a weight of a refuse container, based on the mass of refuse contained in the refuse vehicle.

3. The refuse vehicle of claim 1 comprising the controller, wherein the controller is further configured to make an operational determination, the operational determination comprising triggering a notification indicating for the refuse vehicle to travel to a transfer station to deposit refuse within the body assembly, based on the mass of refuse contained in the refuse vehicle.

4. The refuse vehicle of claim 1 further comprising a lift assembly coupled to the body assembly and communicably coupled to the controller, wherein the controller is further configured to receive the first triggering signal from the lift assembly, based on the lift assembly engaging the refuse container.

5. The refuse vehicle of claim 1 comprising the controller, wherein the controller is further configured to:
receive a second triggering signal indicative of the refuse vehicle engaging a second refuse container;
receive, responsive to the second triggering signal, a second signal from the electronic drive system; and
determine, based on the second signal, a second mass of refuse contained in the body assembly.

6. The refuse vehicle of claim 5, the controller further comprising:
a memory unit;
wherein the controller is further configured to:
store the second signal from the electronic drive system in the memory unit; and
determine, based on comparing the first signal and the second signal, the mass of refuse contained in the body assembly.

7. The refuse vehicle of claim 6 comprising the controller, wherein the controller is further configured to determine, based on comparing the first signal and the second signal, a weight of a refuse container.

8. The refuse vehicle of claim 7 comprising the controller, wherein the controller is further configured to make an operational determination, the operational determination comprising transmitting a notification to a customer corresponding to the refuse container, the notification indicative of the weight of the refuse container.

9. The refuse vehicle of claim 1, wherein the electronic drive system comprises an e-Axle system to at least partially drive the refuse vehicle.

10. A refuse vehicle comprising:
a chassis;
a body assembly coupled to the chassis;
an electronic drive system coupled to the body assembly; and
a controller communicably coupled to the electronic drive system, the controller configured to:
receive a first triggering signal indicative of a first operation of the refuse vehicle;
receive, responsive to the first triggering signal, a first signal from the electronic drive system;
receive a second triggering signal indicative of a second operation of the refuse vehicle different from the first operation;
receive, responsive to the second triggering signal, a second signal from the electronic drive system; and
determine, based on the first signal and the second signal, a mass of refuse contained in the refuse vehicle.

11. The refuse vehicle of claim 10, wherein the first triggering signal is received by the controller before collecting refuse into the body assembly of the refuse vehicle, and the second triggering signal is received by the controller after collecting refuse into the refuse vehicle.

12. The refuse vehicle of claim 10, wherein refuse is collected from a refuse container, the refuse container corresponding to a customer, and wherein the controller is further configured to:
determine an added mass of refuse from the refuse container, based on the mass of refuse contained in the refuse vehicle; and
transmit a notification to the customer, the notification indicative of an added mass of refuse collected from the refuse container.

13. A method for determining a mass of refuse, the method comprising:
receiving a triggering signal indicative of a refuse collection operation of a refuse vehicle;
receiving a signal indicative of an electronic drive system dynamics metric from an electronic drive system of the refuse vehicle responsive to the triggering signal; and
determining a mass of refuse contained within the refuse vehicle, based on the electronic drive system dynamics metric.

14. The method of claim 13, wherein the operation of the refuse vehicle comprises depositing refuse from a refuse container into the refuse vehicle, the refuse vehicle comprising a lift assembly configured to engage the refuse container.

15. The method of claim 13, wherein the electronic drive system dynamics metric is at least one of acceleration, torque, angular velocity, motor power, motor voltage, or pressure for the electronic drive system.

16. The method of claim 13, wherein the triggering signal is a first triggering signal, and the signal is a first signal, the first triggering signal indicative of a first operation of the refuse vehicle, wherein the first operation is performed before collecting refuse into the refuse vehicle.

17. The method of claim 16, further comprising:
receiving a second triggering signal indicative of a second operation of the refuse vehicle; and
receiving a second signal indicative of an electronic drive system dynamics metric of the refuse vehicle, based on the second triggering signal.

18. The method of claim 17, wherein the second operation of the refuse vehicle is performed after depositing refuse into the refuse vehicle.

19. The method of claim 17, further comprising determining an added mass of refuse deposited into the refuse vehicle, based on the first signal and the second signal.

20. The method of claim 17, further comprising determining a first mass of refuse within the refuse vehicle, based on the first signal; and determining a second mass of refuse within the refuse vehicle, based on the second signal.
